(19) United States
(12) Patent Application Publication
(10) Pub. No.: US 2005/0248515 A1
(43) Pub. Date: Nov. 10, 2005

(54) Stabilized active matrix emissive display

(76) Inventors: W. Edward Naugler JR., Cedar Park, TX (US); Damoder Reddy, Los Gatos, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/116,799

(22) Filed: Apr. 27, 2005

Related U.S. Application Data
(60) Provisional application No. 60/566,191, filed on Apr. 28, 2004.

(51) Int. Cl. G09G 3/30

(52) U.S. Cl. 345/77

(57) ABSTRACT

The embodiments of the present invention provide a flat panel display having a plurality of pixels, each comprising a light-emitting device configured to emit light in accordance with a current flowing through the light-emitting device, a transistor coupled to the light-emitting device and configured to provide the current through the light-emitting device, the current increasing with a ramp voltage applied to a control terminal of the transistor, and a switching device configured to switch off in response to the luminance of the light-emitting device having reached a specified level, thereby disconnecting the ramp voltage from the transistor and locking the brightness at the specified level. The ramp voltage is generated in each pixel instead of in peripheral circuits, thereby reducing the number of conducting lines in the display.

### CROSS REFERENCE TO RELATED APPLICATIONS

The present application claims benefit of and priority under 35 U.S.C. 119 and/or 35 U.S.C. 120 to U.S. Provisional Patent Application No. 60/566,191 entitled “Stabilized Flat Panel Display,” filed on Apr. 28, 2004, the entire disclosure of which is incorporated herein by reference.

### FIELD OF THE INVENTION

The present invention relates to active matrix emissive displays and particularly to an improved stabilized active matrix emissive display and method of operating the same.

### BACKGROUND OF THE INVENTION

A flat panel display (FPD) typically includes an array of picture elements (or pixels). Image data for the pixels is converted into electrical signals, which are fed to the pixels to control either the amount of backlight passed by the pixels as in a liquid crystal display (LCD), or to cause the pixels to emit specified amount of light as in, for example, an electro-luminescent LCD display, or an organic light emitting diode (OLED) display. An active matrix display generally includes an array of pixels arranged in rows and columns, each pixel containing a sample and hold circuit, and, if the display is an emissive display, a power thin film transistor (TFT). One advantage of the active matrix is that each line of pixels of the display is held at their respective luminance values for a full frame length so that an instantaneous brightness of the pixels is close to an average brightness for the pixels. On the other hand, pixels in a passive display are on only one line at a time; therefore, each line must have an instantaneous brightness equal to the average brightness multiplied by the number of lines. The active matrix display generally has a longer lifetime, lower power consumption and is capable of many times the line capability of the passive display. In general, all full color monitor, laptop and video flat panel displays employ the active matrix while low resolution monochromatic, area colors, or icons are passive.

In an active matrix OLED display, each pixel typically comprises an OLED and a power thin-film transistor (TFT) coupled to the OLED. A voltage is placed on the gate of the power transistor in a pixel, which feeds current to the OLED. The higher the gate voltage, the higher the current, and the greater the luminance of the pixel. Due to manufacturing tolerances, current parameters of the power transistors typically vary from pixel to pixel. Also the amount of light emitted by the OLED varies depending on the OLED's current-to-light conversion efficiency, the age of the OLED, the environment to which individual pixels of are exposed, and other factors. For example, the OLEDs at an edge of the display may age differently than those in the interior near the center, and OLEDs that are subject to direct sunlight may age differently than those that are shaded or partially shaded. Therefore, uniformity in an emissive display is often a problem.

Any display that is required to produce a number of gray shades should have a uniformity measure greater than one shade of gray. For example, a display with a hundred shades of gray requires a uniformity of 1% in order to produce one hundred brightness levels. For a thousand gray levels, 0.1% brightness uniformity is desired. Such high level of uniformity, however, is often difficult to produce and/or to maintain in the thin film area.

In addition to the uniformity problem, active matrix emissive displays often are designed in a manner that they consume excessive amounts of power. In order to faithfully convert a voltage data to a specified current through the power TFT and thus to a specified luminance of the OLED, changes in the load of the TFT due to changes in the luminance of the OLED should not cause changes in the current output from the power TFT. Thus, the power TFT should act as a current source and not change current output as the load changes. In order for the power TFT to act as a current source, a voltage across the power TFT must bias the power TFT in the saturation mode. To ensure that the power TFT operates in the saturation mode during the lifetime of the display, an excessive amount of voltage from a power supply is typically placed across the power TFT and the OLED to compensate for changes caused by effects such as TFT threshold voltage shift, OLED aging, and the like, which are expected to occur during the lifetime of the display.

Thus, there is a need for a display that provides good control of pixel luminance and meets the display uniformity requirement, without excessive power dissipation by the power TFTs.

### SUMMARY OF THE INVENTION

The embodiments of the present invention provide a display having a plurality of pixels. Each pixel comprises a light-emitting device configured to emit light or photons in response to a current flowing through the light-emitting device. The luminance of the light-emitting device depends on the current through the light-emitting device. Each pixel further comprises a transistor coupled to the light-emitting device and configured to provide the current through the light-emitting device, the current increasing with a ramp voltage applied to a control terminal of the transistor, and a switching device configured to switch off in response to the luminance of the light-emitting device having reached a specified level, thereby stopping the ramp voltage from further increasing and locking the pixel luminance at the specified level. The switching device is further configured to stay off thereby allowing the luminance of the light-emitting device to be kept at the specified level until the pixel is rewritten in the next frame.

In some embodiments, the ramp voltage is generated within each pixel, thereby eliminating the need of a separate conductive line to connect each line of pixels to a ramp voltage supply. In further embodiments, an optical sensor is provided for each pixel to provide a feedback measure for the pixel luminance. The feedback measure is provided to a control circuit via a conductive line associated with a column of pixels, which also connects a control gate of each switching device in the column of pixels to the control circuit. The control circuit is configured to turn off the switching device in response to the feedback measure having reached a reference level corresponding to the specified luminance of the pixel.

The embodiments of the present invention also provide a method for controlling the brightness or luminance of a pixel in a display. The method comprises outputting a line select voltage to a row line associated with a line of pixels, thereby turning on a switching device in each of the line of pixels. The method may further comprise generating a ramp voltage in each of the line of pixels, the ramp voltage being applied to a gate of a power TFT and causing the TFT to conduct current. The current flows through a light-emitting device serially coupled with the power TFT and causes the light-emitting device to emit light. The method may further comprise detecting a portion of the emitted light in a pixel using an optical sensor associated with the pixel, which provides a feedback measure for the luminance of the pixel to a control circuit associated with a column of pixels via a column line, which also connects the switching device in each of the column of pixels to the control circuit. The method may further comprise turning off the switching device in the pixel in response to the feedback measure having reached a reference level corresponding to a specified luminance for the pixel. The switching device is turned off by grounding or lowering the voltage of the column line via the control circuit.

### DESCRIPTION OF THE DRAWINGS

FIG. 1A is a block diagram of an emissive feedback circuit in a display according to one embodiment of the present invention.

FIG. 1B is a block diagram of an emissive feedback circuit in a display having a plurality of pixels according to one embodiment of the present invention.

FIG. 2 is a schematic diagram of a portion of a display circuit according to one embodiment of the present invention.

FIG. 3 is a block diagram of an emissive feedback circuit in a display having a plurality of pixels according to an alternative embodiment of the present invention.

FIG. 4 is a block diagram of an emissive feedback circuit shown in FIG. 3 and formed on two separate substrates.

FIG. 5 is a schematic diagram of a portion of the display circuit shown in FIG. 3.

FIG. 6 is a schematic diagram of a larger portion of the display circuit according to an embodiment of the present invention.

### DETAILED DESCRIPTION OF THE EMBODIMENTS

Embodiments of the present invention provide improved stabilized emissive displays and methods of operating the same. The embodiments described herein improve reliability and reduce costs associated with manufacturing the displays by providing a display circuitry with reduced number of conducting lines interconnecting the pixels in the displays to control circuits.

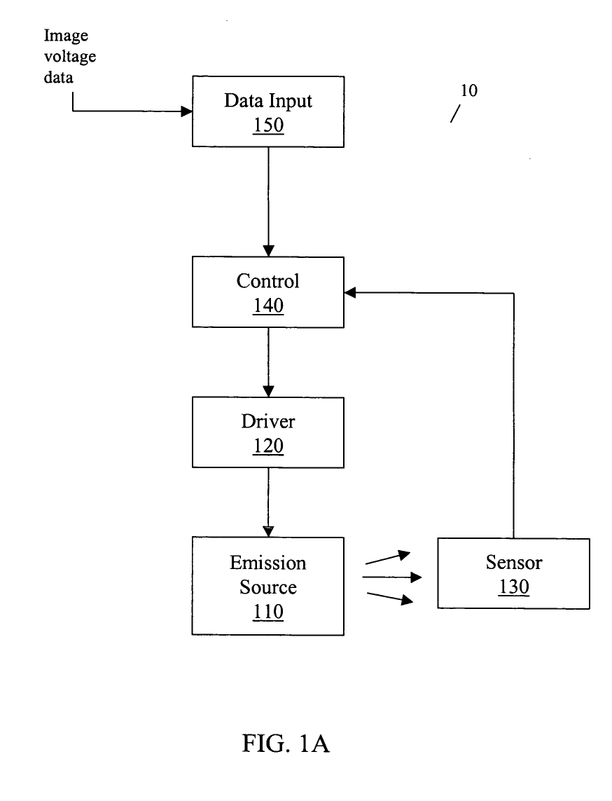

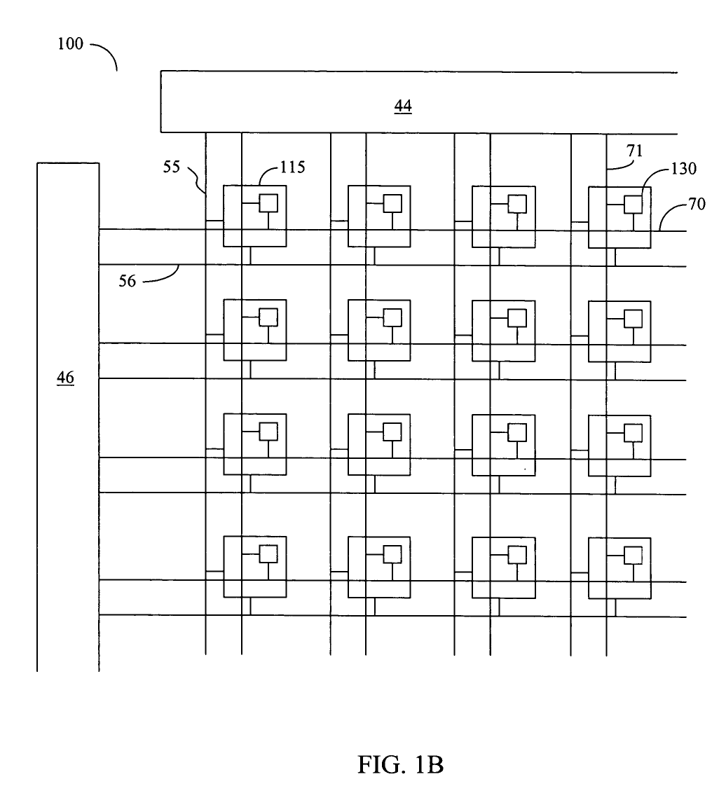

FIG. 1A is a block diagram of a portion of an exemplary emissive feedback display, such as a flat panel display, a display circuit 10 according to one embodiment of the present invention. As shown in FIG. 1A, display circuit 10 comprises a light emission source 110, an emission driver 120 configured to vary the luminance of the emission source 110, an optical sensor 130 positioned to receive a portion of the light emitted from emission source 110 and having an associated electrical parameter dependent on the received light, a control unit 140 configured to control the driver 120 based on the changes in the electrical parameter of the sensor 130, and a data input unit 150 configured to provide a signal corresponding to a desired luminance level for the emission source 110 to the control unit 140.

During operation of display circuit 10, data input 150 receives image voltage data corresponding to a desired brightness (or luminance) of the light from emission source 110 and converts the image voltage data to a reference voltage for use by the control unit 140. The pixel driver 120 is configured to vary the light emission from the emission source 110 until the electrical parameter in sensor 130 reaches a certain value corresponding to the reference voltage, at which point, control unit 140 couples a control signal to driver 120 to stop the variation of the light emission. Driver 120 also comprises mechanisms for maintaining the light emission from emission source 110 at the desired brightness after the variation of the light emission is stopped.

Although FIG. 1A only shows one light emission source 110 and one sensor 130, in practice, there may be an array of light emission sources and an array of sensors in a display using display circuit 10. Referring to FIG. 1B, which is a block diagram of a display 100 according to one embodiment of the present invention, display 100 comprises a plurality of pixels 115 each having a driver 120 and an emission source 110, and a plurality of sensors 130 each corresponding to a pixel. Display 100 further comprises a column control circuit 44 and a row control circuit 46. Each pixel 115 is coupled to the column control circuit 44 via a column line 55 and to the row control circuit 46 via a row line 56. Each sensor 130 is coupled to the row control circuit 46 via a sensor row line 70 and to the column control circuit 44 via a sensor column line 71. In one embodiment, at least parts of the control unit 140 and the data input unit 150 are comprised in the column control circuit 44.

In one embodiment, each sensor 130 is associated with a respective pixel 115 and is positioned to receive a portion of the light emitted from the pixel. The row control circuit 46 is configured to activate a selected row of sensors 60 by, for example, raising a voltage on a selected sensor row line 70, which couples the selected row of sensors to the row control circuit 46. The column control circuit 44 is configured to detect changes in the electrical parameters associated with the selected row of sensors and to control the luminance of the corresponding row of pixels 115 based on the changes in the electrical parameters. This way, the luminance of each pixel can be controlled at a specified level based on a feedback from the sensor 130. In other embodiments, the sensors 130 may be used for purposes other than or in addition to feedback control of the pixel luminance, and there may be more or less sensors 130 than the pixels or subpixels 115 in a display.

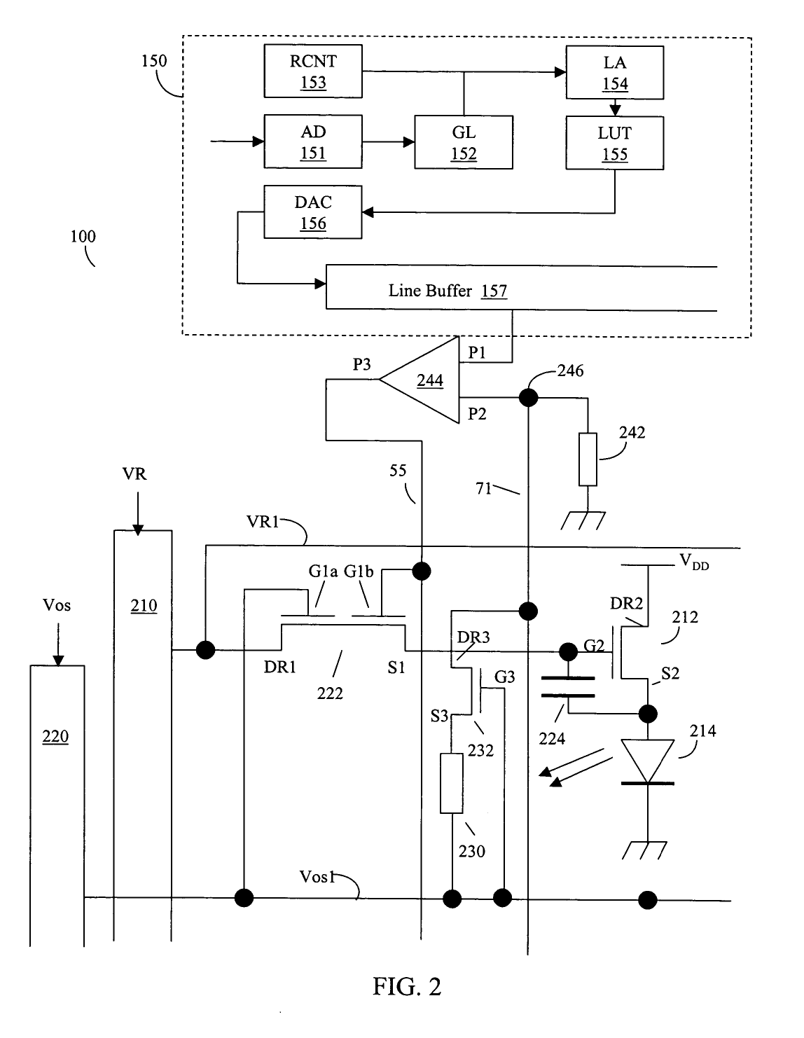

FIG. 2 illustrates one implementation of the display circuit 100. For clarity, only one pixel and its associated sensor are shown. In reality, display 100 may comprise many pixels and sensors, as shown in FIG. 11B. Referring now to FIG. 2, display circuit 100 comprises a light-emitting device 214 as the light emission source 110, and a power transistor 212, a switching device 222, and a charge storage device or capacitor 224 as part of the driver 120, an optical sensor (OS) 230 and an optional isolation device 232 as sensor 130, and a voltage divider resistor 242 and a comparator 244 as part of the control unit 140.

Display 100 further comprises ramp selector (RS) 210 configured to receive a ramp voltage VR and to select a row line, such as row line VR1, to output the ramp voltage VR. Circuit 100 further comprises a line selector (V_{OS}S) configured to receive a line select voltage Vos and to select a sensor row line, such as sensor row line V_{OS}1, to output the line select voltage V_{OS}. RS 210 and VosS 220 can be implemented using shift registers.

Optical sensor (OS) 230 is coupled to a sensor row line (e.g., V_{OS1}) and voltage divider resistor 242 is coupled though isolation TFT 232 with OS 230. Comparator 244 has a first input P1 coupled to data input unit 150, a second input P2 coupled to a circuit node 246 between OS 230 and voltage divider resistor 242, and an output P3. Switching device 222 has a first control terminal G1a coupled to a sensor row line (e.g., V_{OS1}), a second control terminal G1b coupled to output P3 of comparator 244 through a column line 55, an input DR1 coupled to a row line (e.g., VR1), and an output S1 coupled to a control terminal G2 of transistor 212. Capacitor 224 is coupled between control terminal G2 and a circuit node S2 between transistor 212 and light-emitting device 214. Capacitor 224 may alternatively be coupled between control terminal G2 of transistor 212 and ground, between control terminal G2 and a drain DR2 of transistor 212, or between control terminal G2 of transistor 212 and power supply V_{DD}.

Each OS 230 can be any suitable sensor having a measurable property, such as a resistance, capacitance, inductance, or the like parameter, property, or characteristic, dependent on received photo emissions. An example of OS 230 is a photosensitive resistor whose resistance varies with incident photon flux. Thus, each OS 230 may include at least one type of material that has one or more electrical properties changing according to the intensity of radiation falling or impinging on a surface of the material. Such materials include but are not limited to amorphous silicon (a-Si), cadmium selenide (CdSe), silicon (Si), and Selenium (Se). Other radiation-sensitive sensors may also or alternatively be used including, but not limited to, optical diodes, and/or optical transistors.

Isolation device 232 such as an isolation transistor may be provided to isolate the optical sensors 230. Isolation transistor 232 can be any type of transistor having first and second terminals and a control terminal, with conductivity between the first and second terminals controllable by a control voltage applied to the control terminal. In one embodiment, isolation transistor 232 is a TFT with the first terminal being a drain DR3, the second terminal being a source S3, and the control terminal being a gate G3. The isolation transistor 232 is serially coupled with OS 230 between OS 230 and a sensor column line 71, with the control terminal of G3 connected to V_{OS1}, while the first and second terminals are connected to OS 230 and resistor 242 via the sensor column line 71, respectively, or to V_{OS1} and OS 230, respectively. In the following discussion, OS 230 and isolation transistor 232 may together be referred to as sensor 130.

Light-emitting device 214 may generally be any light-emitting device known in the art that produces radiation such as light emissions or photons in response to an electrical measure such as an electrical current through the device or an electrical voltage across the device. Examples of light-emitting device 214 include but are not limited to light emitting diodes (LED) and organic light emitting diodes (OLED) that emit light at any wavelength or a plurality of wavelengths. Other light-emitting devices may be used including but not limited to electroluminescent cells, inorganic light emitting diodes, and those used in vacuum florescent displays, field emission displays and plasma displays. In one embodiment, an OLED is used as the light-emitting device 214.

Light-emitting device 214 is sometimes referred to as an OLED 214 hereafter. But, it will be appreciated that the invention is not limited to using an OLED as the light-emitting device 214. Furthermore, although the invention is sometimes described relative to a flat panel display, it will be appreciated that many aspects of the embodiments described herein are applicable to a display that is not flat or built as a panel.

Transistor 212 can be any type of transistor or control device having a first terminal, a second terminal, and at least one control terminal, with the current between the first and second terminals dependent on a control voltage applied to the control terminal. In one embodiment, transistor 212 is a TFT with the first terminal being a drain DR2, the second terminal being a source S2, and the control terminal being a gate G2. Transistor 212 and light-emitting device 214 are serially coupled between a power supply V_{DD} and ground, with the first terminal DR2 of transistor 212 connected to V_{DD}, the second terminal S2 of transistor 212 connected to the light-emitting device 214, and the control terminal G2 connected to ramp voltage output VR through switching device 222.

In one embodiment, switching device 222 is a double-gated TFT, that is, a TFT with a single channel but two gates G1a and G1b. The double gates act like an AND function in logic, because for the TFT 222 to conduct, logic highs need to be simultaneously applied to both gates. Although a double-gated TFT is preferred, any switching device implementing the AND function in logic is suitable for use as the switching device 222. For example, two serially coupled TFTs or other types of transistors may be used as the switching device 222. Use of a double-gated TFT or other device implementing the AND function in logic as the switching device 222 helps to reduce cross talk between pixels, as explained in more detail below. If cross talk is not a concern or other means are used to reduce or eliminate the cross talk, gate G1a and its connection to V_{OS1} is not required, and a TFT with a single control gate connected to the output P3 of comparator 244 may be used as the switching device 222.

FIG. 2 also shows a block diagram of data input unit 150, which comprises an analog to digital converter (A/D) 151 configured to convert a received analog image voltage data to a corresponding digital value, an optional grayscale level calculator (GL) 152 coupled to the A/D 151 and configured to generate a grayscale level corresponding to the digital value, a row and column tracker unit (RCNT) 153 configured to generate a line number and column number for the image voltage data, a calibration look-up table addresser (LA) 154 coupled to the RCNT 153 and configured to output an address in the display circuit 100 corresponding to the line number and column number, and a first look-up table (LUT) 155 coupled to the GL 152 and the LA 154. Data input unit 150 further comprises a digital to analog converter (DAC) 156 coupled to the LUT 155 and a line buffer (LB) 157 coupled to the DAC 156.

In one embodiment, LUT 155 stores calibration data obtained during a calibration process for calibrating optical sensor 230 against a light source with a known luminance. An exemplary calibration process is discussed in commonly assigned U.S. patent application Ser. No. 10/872,344, entitled “Method and Apparatus for Controlling an Active Matrix Display,” filed Jun. 17, 2004, and commonly assigned U.S. patent application Ser. No. 10/841,198 entitled “Method and Apparatus for Controlling Pixel Emission,” filed May 6, 2004, each of which is incorporated herein by reference. The calibration process produces a voltage divider voltage level at circuit node 246 in each pixel for each grayscale level. As a non-limiting example, an 8-bit grayscale has 0-255 levels of luminance with the 255^{th} level being at a chosen level, such as 300 nits for a Television screen. The luminance level for each of the remaining 254 levels is assigned according to the logarithmic response of the human eye. The zero level corresponds to no emission.

Each level of pixel luminance should produce a specific voltage on the circuit node 246 between optical sensor OS 230 and voltage divider resistor 242. These voltage values are stored in lookup table LUT 155 as the calibration data. Thus, based on the address provided by LA 154 and the gray scale level provided by GL 152, the LUT 155 generates a calibrated voltage from the stored calibration data and provides the calibrated voltage to DAC 156, which converts the calibrated voltage into an analog voltage value and downloads the analog voltage value to LB 157. Image data voltages for a row of pixels in display 100 are sent to the A/D converter 151 serially and each is converted to a reference voltage and stored in LB1156 until LB1 stores the reference voltages for every pixel in the row. Line buffer 157 provides the analog voltage value for each of a row of pixels as a reference voltage to input P1 of comparator 244 associated with the column corresponding to the address.

In one embodiment, comparator 244 is a voltage comparator that compares the voltage levels at its two inputs P1 and P2 and generates at its output P3 a positive supply rail (e.g., +10 volts) when P1 is larger than P2 and a negative supply rail (e.g., 0 volts) when P1 is equal or less than P2. The positive supply rail corresponds to a logic high for the switching device 222 while negative supply rail corresponds to a logic low for the switching device 222. To select a row of pixels, such as the row including the pixel shown in FIG. 2, ramp selector 210 selects the row line (e.g., VR1) corresponding to the row of pixels to output ramp voltage VR, and VosS selects sensor row line (e.g., Vos1) to output row select voltage Vos. Initially, before OLED 214 emits light, OS 230 has a maximum resistance to current flow; and voltage on input pin P2 of VC 244 is minimum because the resistance R of voltage divider resistor 242 is small compared to the resistance of OS 230. So, as the reference voltages for the a row of pixels are written to line buffer 157, gate G1b in each of the row of pixels is opened because input P1 in each comparator 244 is supplied with a reference voltage while input P2 in each comparator 244 is grounded, causing comparator 244 to generate the positive supply rail at output P3.

At about the same time, shift register Vos 220 sends the line select voltage V_{OS} (e.g., +10 volts) to line Vos1, turning on gate G1a of each switching device 224 in row 1, and thus also turning on the switching devices 222 themselves (since gate G1b is already on). The voltage V_{OS} on line Vos1 is also applied to OS 230 and to the gate G3 of transistor 232 in each of the first row of pixels, causing transistor 232 to conduct and current to flow through OS 230. Also at about the same time, shift register RS 210 sends the ramp voltage VR (e.g., from 0 to 10 volts) to line VR1, which ramp voltage is applied to storage capacitor 224 and to the gate G2 of transistor 212 in each pixel in row 1 because switching device 222 is conducting. As the voltage on line VR1 is ramped up, the capacitor 224 is increasingly charged, the current through transistor 212 and OLED 214 in each of the first row of pixels increases, and the light emission from the OLED also increases. The increasing light emission from the OLED 214 in each pixel in row 1 falls on OS 230 associated with the pixel and causes the resistance associated with the OS 230 to decrease, and thus, the voltage across resistor 242 or the voltage at input P2 of comparator 244 to increase.

This continues in each pixel in the selected row as the OLED 214 in the pixel ramps up in luminance with the increase of ramp voltage VR until the OLED 214 reaches a specified luminance for the pixel and the voltage at input P2 is equal to the reference voltage at input P1 of comparator 244. In response, output P3 of comparator 244 changes from the positive supply rail to the negative supply rail, turning off gate G1b of switching device 222 in the pixel, and thus, the switching device itself. With the switching device 222 turned off, further increase in VR is not applied to gate G of transistor 212 in the pixel, and the voltage between gate G2 and the second terminal S2 of transistor 212 is held constant by capacitor 224 in the pixel. Therefore, the emission level from OLED 214 in the pixel is frozen or fixed at the desired level as determined by the calibrated reference voltage placed on pin, P1 of the voltage comparator 244 associated with the pixel.

The duration of time that the ramp voltage VR takes to increase to its full value is called the line address time. In a display having 500 lines and running at 60 frames per second, the line address time is approximately 33 micro seconds or shorter. Therefore, all the pixels in the selected row are at their respective desired emission levels by the end of the line address time. And this completes the writing of selected row in the display 100. After the selected row is written, both horizontal shift registers, V_{OS}S 220 and RS 210 turn off lines VR1 and Vos1, respectively, causing switching device 222 and isolation transistor 232 to be turned off, thereby, locking the voltage on the storage capacitor 224 and isolating the optical sensors 230 in the row from the voltage comparators 244 associated with each column. When this happens, the voltage on pin P2 of each comparator 244 goes to ground as no current flows in resistor R, causing the output P3 of the voltage comparator 244 to go back to the positive supply rail, turning gate G1b of switching device 222 in each related pixel back on, ready for the writing of the next row of pixels in display 100.

During the writing of the next row, image data associated with the next row is supplied to A/D 151, ramp selector RS 210 selects the row line associated with the next row to output ramp voltage VR, line selector V_{OS}S 220 selects the sensor row line associated with the next row to output line select voltage Vos, and the previous operation is repeated for the next row of pixels until they are turned on. This continues until all rows in the display 100 have been turned on, and then the frame repeats. In the embodiments depicted by FIG. 2, each switching device 222 has double gates, Gate G1a and Gate G1b, and gate G1a of each switching device 222 in each row is held by the respective sensor row line, such as Vos1. So, during the writing of subsequent rows, while gate G1b may conduct, the switching devices 222 in unselected rows are kept off because the associated sensor row lines are not selected. Thus, capacitor 224 in each pixel in the unselected rows is kept disconnected from the capacitors 224 in the other pixels. This eliminates cross talk between capacitors 224 in different pixels in the rows that has just be written, so that each pixel in the unselected rows continues to output the desired emission level during the writing of subsequent rows.

The embodiments described above provide an emission feedback control system for controlling the luminance of each pixel in a display. Because the luminance of each pixel 115 in the display 100 does not depend on a voltage-current relationship associated with transistor 212, but is controlled by a specified image grayscale level and a feedback of the pixel luminance itself, the embodiments described above provide a more stabilized display than those built using conventional techniques. The embodiments also allow transistor 212 to operate in the unsaturated region, and thus, save power for the operation of display 100.

Display 100, however, requires more conducting lines than a conventional flat panel display because of the inclusion of a sensor array. As shown in FIG. 1B and FIG. 2, a sensor row line 70 (e.g., Vos1) is provided for each row in addition to a row line 56 (e.g., VR1), and a sensor column line 71 is provided for each column in addition to a column line 55, in order to connect the pixels and sensors to their respective control circuitry in the row and column control circuits 46 and 44. In a typical conventional full-color VGA display, there may be 1920 column lines and 480 row lines, in addition to power and ground conducting lines. Display 100 may double those numbers because of the addition of sensor row lines and sensor column lines, requiring, for example, more than 4800 conductive lines on the display glass. Since some or all of the control circuitry may be fabricated off the glass on which the pixels and/or the sensors are formed, cables are often provided to connect the conductive lines to the control circuitry, each cable having one end connected to a conducting line and another end connected to a terminal in the off-glass control circuitry. Thus, display 100 may require nearly 10,000 electrical connections at the ends of the cables.

The added conducting lines in display 100 take up room on the display and reduce pixel aperture. Furthermore, since the conducting lines are in rows and columns, they need to cross each other and be insulated from each other by one or more dielectric layers. Each crossover point is a potential short through any pinholes that may exist in the dielectric layer. Therefore, the added conductive lines increase yield loss due to the increased number of crossover points. Moreover, every electrical connection can be a potential liability problem, and the increased number of electrical connections associated with the use of cables increases the number of potential liability problems associated with the display.

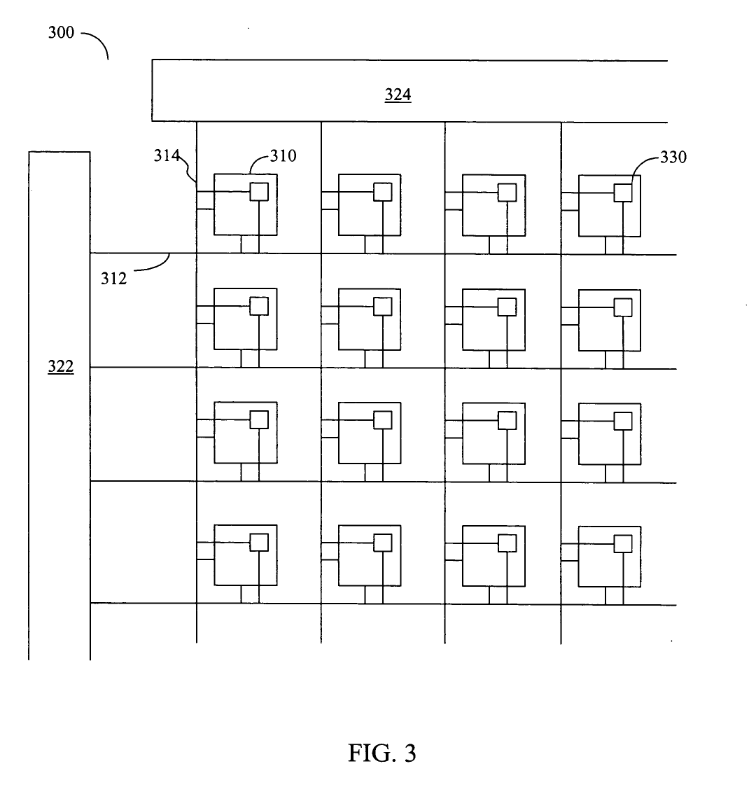

Referring to FIG. 3, a display 300 according to alternative embodiments of the present invention comprises a plurality of pixels 310, each being connected to a row select circuit 322 via a row line 312 and to a column control circuit 324 via a column line 314. Display 300 further comprises a plurality of sensors 330 each associated with a pixel 310. Unlike display 100 shown in FIG. 1B, which requires a separate set of sensor row lines 70 and a separate set of sensor column lines 71 to connect the sensors to the row control circuit 46 and to the column control circuit 44, respectively, each sensor 330 in display 300 can be connected to the row select circuit 322 via one of the row lines 312 and to a column control circuit 324 via one of the column lines 314, therefore eliminating the need for a separate set of sensor row lines and a separate set of sensor column lines.

Pixels 310 are generally square, as shown in FIG. 3, but can be any shape such as rectangular, round, oval, hexagonal, polygonal, or any other shape. If display 300 is a color display, pixel 310 can also be subpixels organized in groups, each group corresponding to a pixel. The subpixels in a group should advantageously include a number (e.g., 3) of subpixels each occupying a portion of the area designated for the corresponding pixel. For example, if each pixel is in the shape of a square, the subpixels are generally as high as the pixel, but only a fraction (e.g., ⅓) of the width of the square. Subpixels may be identically sized or shaped, or they may have different sizes and shapes. Each subpixel may include the same circuit elements as pixel 310 and the sub-pixels in a display can be interconnected with each other and to the row select circuit 322 and column control circuit 324 just as the pixels 310 shown in FIG. 3. In a color display, a sensor 330 is associated with each subpixel. For ease of discussion, the word “pixel” herein may mean either pixel or subpixel.

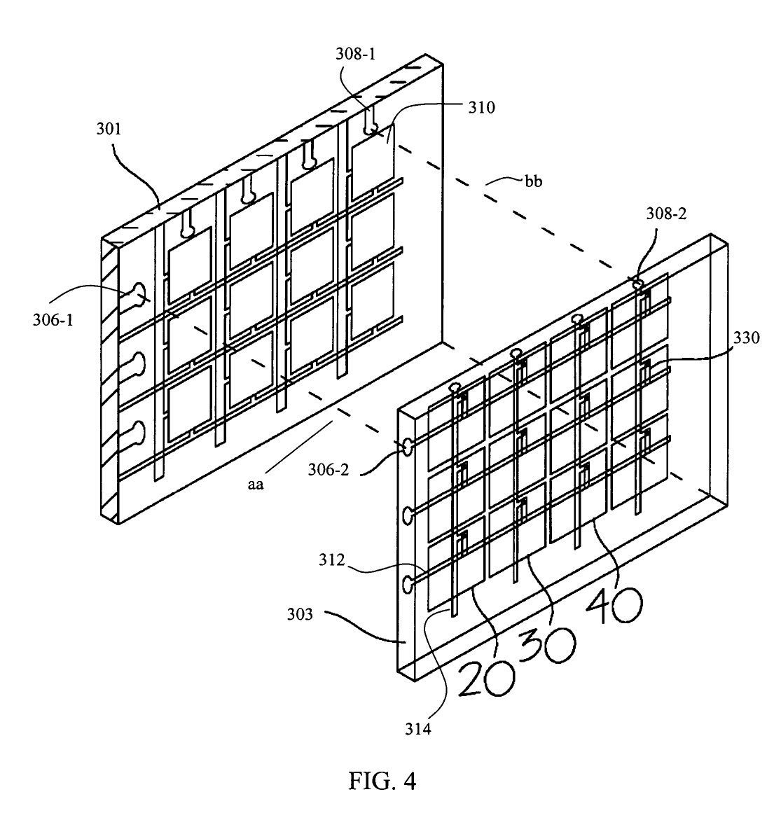

The sensors 330 and the pixels 310 can be formed on a same substrate, or, they can be formed on different substrates. In one embodiment, display 300 comprises a display component 301 and a sensor component 303, as illustrated in FIG. 4. The display component 301 comprises pixels 310, while the sensor component 303 comprises the sensors 330, another set of row lines 312, and another set of column lines 314 formed on a second substrate 303. The sensor component 303 may also comprise color filter elements 20, 30, and 40 when the sensors 330 are integrated with a color filter for the display, as described in commonly assigned Patent Application Attorney Docket Number 186351/US/2/RMA/JJZ (474125-35), entitled “Color Filter Integrated with Sensor Array for Flat Panel Display,” filed Apr. 6, 2005, which is incorporated herein by reference in its entirety.

When the two components are put together to form display 300, electrical contact pads or pins 306-1 on display component 301 are mated with electrical contact pads 306-2 on sensor component 303, as indicated by the dotted line “aa”, in order to connect the row lines 312 on the sensor component 303 to the row control circuit 322 (not shown in FIG. 3). Likewise, electrical contact pads or pins 308-1 on display component 301 are mated with electrical contact pads 308-2 on sensor component 303, as indicated by the dotted line “bb”, in order to connect the column lines 314 to the column control circuit 324 (not shown). For ease of illustration, other conducting lines, such as ground lines and power lines, are not shown in FIG. 3.

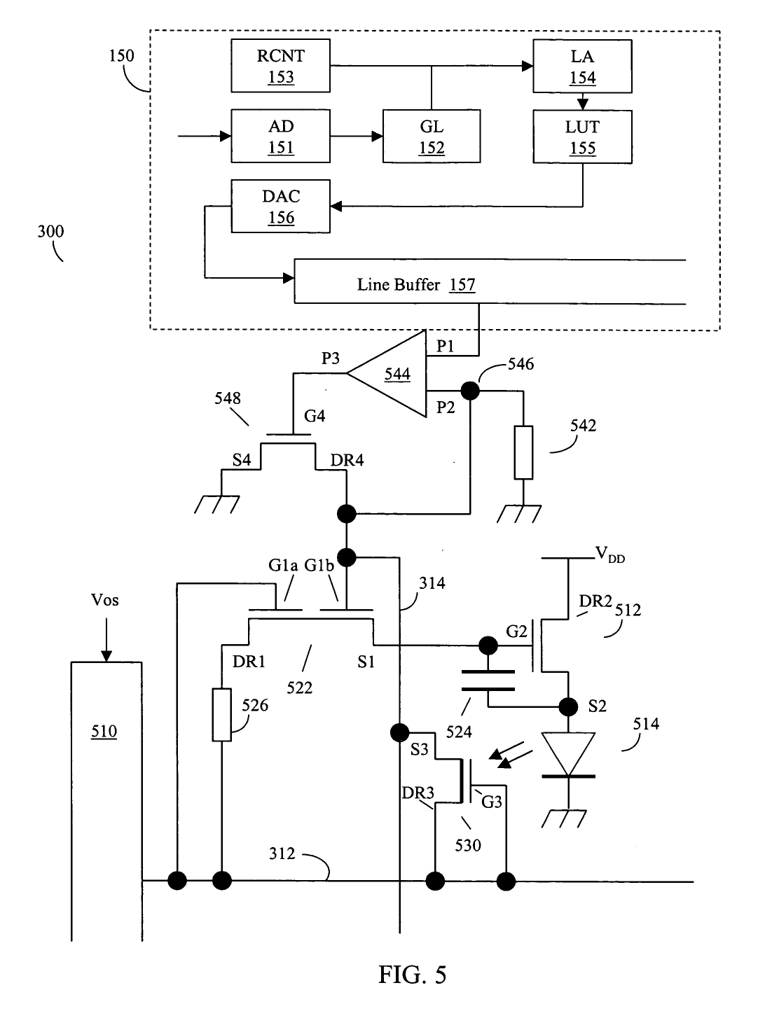

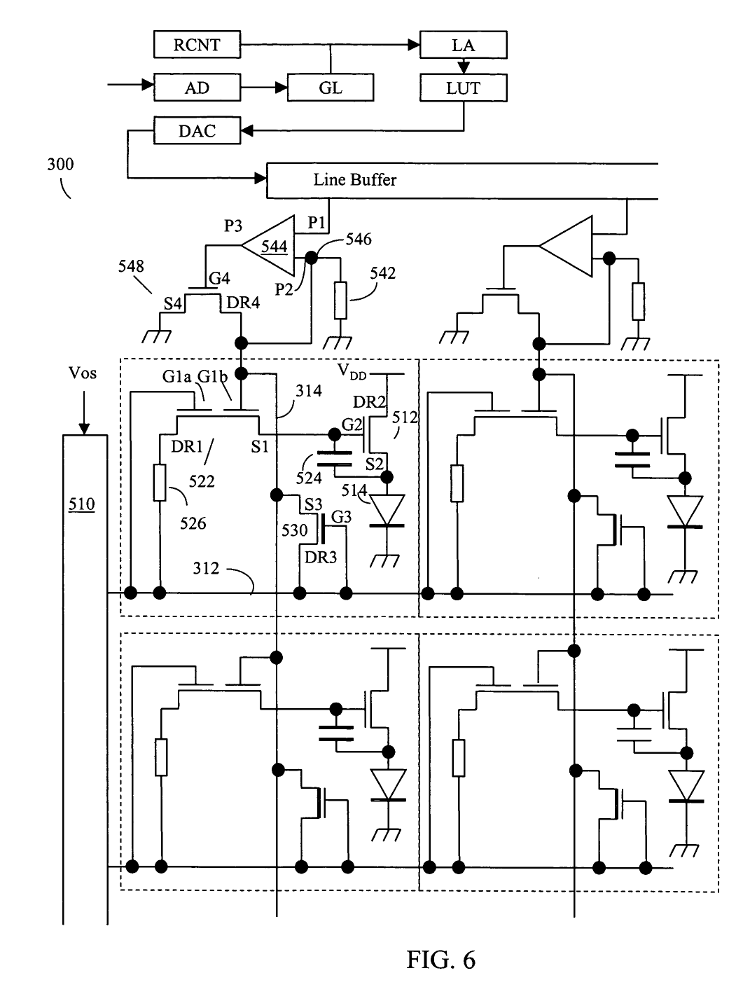

FIG. 5 illustrates one implementation of display 300 according to one embodiment of the present invention. For clarity, only one pixel, its associated sensor, and the respective row line 312 and column line 314 are shown. In reality, display 300 may comprise a plurality of pixels and sensors interconnected to each other and to peripheral circuits by a set of row lines and a set of column lines, as shown in FIG. 3 and in FIG. 6, which is referred to below. Referring now to FIG. 5, display 300 comprises a light-emitting device 514 as the light emission source 110, and a transistor 512, a switching device 522, a charge storage device or capacitor 524, and a resistor 526 as part of the driver 120. Display 300 further comprises an optical sensor (OS) 530 as sensor 130, and a voltage divider resistor 542, a comparator 544, and a transistor 548 as part of the control unit 140.

Display 300 further comprises a line selector (V_{OS}S) 510 configured to receive a line select voltage Vos and to select a row line 312, to output the line select voltage V_{OS}. VosS 510 can be implemented using shift registers.

The comparator 544 has a first input P1 coupled to the data input unit 150, a second input P2 coupled to the respective column line 314, and an output P3 connected to a gate G4 of transistor 548, which has its source and drain connected to the ground and the column line 314, respectively. The switching device 522 has a first control terminal G1a coupled to the row line 312, a second control terminal G1b coupled to the column line 314, an input DR1 coupled to the row line 312 through resistor 526, and an output SI coupled to a control terminal G2 of transistor 512. The capacitor 524 is coupled between the control terminal G2 and a circuit node S2 between transistor 512 and light-emitting device 514. The capacitor 524 may alternatively be coupled between control terminal G2 of transistor 512 and ground, between control terminal G2 and drain DR2 of transistor 512, or between control terminal G2 and power supply V_{DD}.

Each OS 530 can be any suitable sensor having a measurable property, such as a resistance, capacitance, inductance, or the like parameter, property, or characteristic, dependent on received emissions. An example of OS 530 is a photosensitive resistor whose resistance varies with an incident photon flux or an optical transistor whose source-drain resistance is dependent upon the incident photon flux. When OS is an optical transistor, as shown in FIG. 5, OS 530 has its gate and drain tied to the respective row line 312 and its source connected to the respective column line 314. When OS is a photosensitive resistor, such as the one shown in FIG. 2, an isolation transistor may be provided to prevent cross talk, as shown in FIG. 2. The isolation transistor would be serially connected between the photosensitive resistor and the respective column line 314 and having its gate connected to the respective row line 312. Thus, each OS 530 may include at least one type of material that has one or more electrical properties changing according to the intensity of radiation falling or impinging on a surface of the material. Such materials include but are not limited to amorphous silicon (a-Si), cadmium selenide (CdSe), silicon (Si), and Selenium (Se). Other radiation-sensitive sensors, such as, optical diodes, may also be used.

Light-emitting device 514 may generally be any light-emitting device known in the art that produces radiation such as light emissions in response to an electrical measure such as an electrical current through the device or an electrical voltage across the device. Examples of light-emitting device 514 include but are not limited to light emitting diodes (LED) and organic light emitting diodes (OLED) that emit light at any wavelength or a plurality of wavelengths. Other light-emitting devices may be used including electroluminescent cells, inorganic light emitting diodes, and those used in vacuum florescent displays, field emission displays and plasma displays. In one embodiment, an OLED is used as the light-emitting device 514.

Like light-emitting device 214, light-emitting device 514 is sometimes referred to as an OLED 514 hereafter. But it will be appreciated that the invention is not limited to using an OLED as the light-emitting device 514. Furthermore, although the invention is sometimes described relative to a flat panel display, it will be appreciated that many aspects of the embodiments described herein are applicable to a display that is not flat or built as a panel.

Like transistor 212, transistor 512 can be any type of transistor having a first terminal, a second terminal, and a control terminal, with the current between the first and second terminals dependent on a control voltage applied to the control terminal. In one embodiment, transistor 512 is a TFT with the first terminal being a drain DR2, the second terminal being a source S2, and the control terminal being a gate G2. Transistor 512 and light-emitting device 514 are serially coupled between a power supply V_{DD} and ground, with the first terminal of transistor 512 connected to V_{DD}, the second terminal of transistor 512 connected to the light-emitting device 514, and the control terminal connected to ramp voltage output VR through switching device 522. The semiconductor material used in the TFTs (thin film transistors) may be any suitable semiconductor material including but not limited to amorphous silicon, poly-silicon and cadmium selenide to name a few.

Transistor 548 can be any type of field-effect transistor (FET) having a first terminal, a second terminal, and a control terminal, with the current between the first and second terminals dependent on a control voltage applied to the control terminal. In one embodiment, transistor 548 is a FET with the first terminal being a drain DR4 connected to the column line 314, the second terminal being a source S4 connected to ground, and the control terminal being a gate G4 connected to the output P3 of VC 544.

In one embodiment, switching device 522 is a double-gated TFT, that is, a TFT with a single channel between an input (or drain) DR1 and output (or source) S1 and two gates G1a and G1b over the channel. The double gates act like an AND function in logic, because for the TFT 522 to conduct, logic highs need to be simultaneously applied to both gates. Although a double-gated TFT is preferred, any switching device implementing the AND function in logic is suitable for use as the switching device 522. For example, two serially coupled TFTs or other types of transistors may be used as the switching device 522. Use of a double-gated TFT or other device implementing the AND function in logic as the switching device 522 helps to reduce cross talk between pixels, as explained in more detail below. If cross talk is not a concern or other means are used to reduce or eliminate the cross talk, gate G1a and its connection to row line 312 is not required, and a TFT with a single control gate connected to the column line 314 may be used as switching device 522.

FIG. 5 also shows a block diagram of data input unit 150, which is structured and functions similarly as the data input unit shown in FIG. 2. Thus, data unit 150 in FIG. 5 provides, for each pixel in a selected row of pixels, an analog voltage value corresponding to a specified luminance for the pixel as a reference voltage to input P1 of comparator 544 associated with the column in which the pixel resides.

In one embodiment, comparator 544 is a voltage comparator that compares the voltage levels at its two inputs P1 and P2 and generates at its output P3 a negative supply rail (e.g., 0 volts) when P1 is larger than P2 and a positive supply rail (e.g., +10 volts) when P1 is equal or less than P2. The positive supply rail corresponds to a logic high for transistor 548 while the negative supply rail corresponds to a logic low for transistor 548. In one embodiment, line select voltage Vos does not change with time and is at a constant level that is equal or higher than turn-on voltages associated with control gates G1a and G3. To select a row of pixels, such as the row including the pixel shown in FIG. 5, VosS 510 selects a row line 312, such as the row line 312 shown in the figure, to output line select voltage Vos, which turns on gate G1a of switching device 522 and OS 530 (if OS is an optical transistor shown in FIG. 5) or an isolation transistor connected to OS 530 (if OS is an optical resistor). Initially, before OLED 514 emits light, OS 530 has a maximum resistance to current flow; and voltage on input pin P2 of VC 544 is at its minimum because Vos is divided between voltage divider resistor 542 and OS 530. In one embodiment, the resistance R of voltage divider resistor 542 is selected such that for a particular Vos (e.g., 10 V), the minimum voltage at input pin P2 of VC 544 is at a specified initial value (e.g., 5V), which is required to turn on gate G1b of switching device 522. So, when a row of pixels are selected, both gate G1a and gate G1b in each pixel in the row is opened, causing switching device 522 in the pixel to conduct between its input DR1 and output S1.

In one embodiment, resistance R of resistor 542 is about 1 gig ohm, and the resistance of OS 530 at its minimum is also about 1 gig ohm. So when Vos is about 10 volts, about 5 volts of voltage will be on gate G1b of switching device 522.

With the switching device 522 turned on, resister 526 is connected in series with capacitor 524 and with the gate capacitance of transistor 512. Therefore, an RC network exists for the line select voltage Vos to charge up the gate of transistor 512 and capacitor 524. In one embodiment, the resistance value R1 of resistor 526 is selected so that an RC time constant associated with the RC network is on the order of the line address time associated with the display. As an example, for a 100 line flat panel display running 60 frames per second, the line address time is about 167 μs. In one embodiment, resistance R1 of resistor 526 is about 25 mega-ohms, and the combined capacitance of capacitor 524 and gate capacitance of transistor 512 is about 3 pF. This gives a 75 microsecond RC time constant, allowing the capacitor 524 and the gate G2 of transistor 512 to charge up to near the Vos voltage during the line address time. Thus, a ramp function is generated inside the pixel instead of in a peripheral circuit, which would require additional conducting lines to provide the necessary connections. As a result, the number of electrical connections required to connect the pixels in display 300 to off-the-glass control circuitry is significantly reduced. In stead of nearly 10,000 electrical connections required by display 100, display 300 may require only about 5,000 such connections. Furthermore, the reduction in the number of conducting lines in the display glass results in the reduction of crossover points between different layers of conducting lines and thus reduced yield loss due to possible pinholes in the dielectrics between the layers of conducting lines.

The above process is performed in each pixel in a selected row as the light-emitting device 514 in the pixel ramps up in luminance until a specified luminance for the pixel is reached and the voltage at input P2 is equal to the reference voltage at input P1 of the comparator 544 corresponding to the column in which the pixel resides. In response to the voltage at input P2 being equal to the voltage at input P1, the output P3 of comparator 544 is changed from the logic low to the logic high, turning on transistor 548, thereby gate G1b of transistor 522 goes to ground through transistor 548. Since the resistance to ground through transistor 548 when it is turned on can be thousands of times smaller than the resistance to Vos through OS 530, the voltage on gate G1b is essentially zero and switching device 522 is thus turned off. With the switching device 522 off, the RC network is broken because Vos and resistor 526 is disconnected from capacitor 524 and gate G2 of TFT 512. The voltage of gate G2 no longer rises and the luminance of the pixel is thus fixed or frozen at the specified level.

After the selected row is written, horizontal shift register V_{OS}S 510 turns off the Vos output to the row line 312 corresponding to the row, causing switching device 522 and OS 530 to be turned off, thereby, locking the voltage on the storage capacitor 524 and isolating the optical sensors 530 in the row from those in the other rows. When this happens, the voltage on pin P2 of each comparator 544 goes to ground as no current flows in resistor 542, causing the output P3 of the voltage comparator 544 to go back to the negative supply rail, turning off gate G4 of transistor 548, ready for the writing of the next row of pixels in display 300.

During the writing of the next row, as shown in FIG. 6, data unit 150 outputs the reference voltages for the next row of pixels, and VosS 510 selects the row line 312 associated with the next row to output line select voltage Vos, and the previous operation is repeated for the next row of pixels until they are turned on. This continues until all rows in the display 300 have been turned on, and then the frame repeats. In the embodiments depicted by FIGS. 5 and 6, each switching device 522 has double gates, gate G1a and Gate G1b, and gate G1a of each switching device 522 in a row is held by the respective row line 312. So, during the writing of subsequent rows, while gate G1b may conduct, the switching devices 522 in unselected rows are kept off because the associated row lines are not selected. Thus, capacitor 524 in each pixel in the unselected rows is kept disconnected from the capacitors 524 in the other pixels. This eliminates cross talk between capacitors 524 in different pixels in the rows that has just be written, so that each pixel in the unselected rows continues to output the desired emission level during the writing of subsequent rows.

Thus, the embodiments described above provide an improved emission feedback control system for controlling the luminance of each pixel in a display with reduced number of conducting lines.

From the foregoing it will be appreciated that, although specific embodiments of the invention have been described herein for purposes of illustration, various modifications may be made without deviating from the spirit and scope of the invention. For example, although the TFT and FET devices are shown in the drawings as n-channel devices, p-channel devices can also be used. As another example, resistor 542 can be integrated within each pixel instead of being included in an off-the-glass control circuit. Therefore, the embodiments provided above are examples of various circuit solutions within the spirit and scope of this invention. Accordingly, the invention is not limited except as by the appended claims.

1. A display having a plurality of pixels, each pixel comprising:
a light-emitting device configured to emit light in response to a current flowing through the light-emitting device, a luminance of the light-emitting device being dependent upon the current;
a transistor coupled to the light-emitting device and configured to provide the current through the light-emitting device, the current increasing with a ramp voltage applied to a control terminal of the transistor, the ramp voltage being generated in the pixel; and
a first switching device configured to switch off in response to the luminance of the light-emitting device having reached a specified level, thereby locking the luminance of the pixel at the specified level.

2. The display of claim 2, wherein each pixel further comprises a charge storage device or capacitor coupled to the transistor and configured to keep the luminance of the light-emitting device at the specified level after the ramp voltage is disconnected from the transistor.

3. The display of claim 2, wherein the pixels are arranged in rows and columns and interconnected by a set of row lines each associated with a row of pixels and a set of column lines each associated with a column of pixels, and wherein each pixel further comprising a resistor coupled between the first switching device in the pixel and a respective row line, the resistor and the capacitor forming at least part of an RC network for generating the ramp voltage in response to a line select voltage being applied to the row line.

4. The display of claim 3, further comprising an optical sensor associated with each pixel, the optical sensor positioned to receive a portion of the light from the light-emitting device and having an electrical parameter dependent on the luminance of the light-emitting device.

5. The display of claim 4, wherein the optical sensor is an optical transistor having a control terminal connected to a respective row line.

6. The display of claim 4, wherein the optical sensor comprises a photosensitive resistor and a second switching device serially coupled with the photosensitive resistor between the respective row line and a respective column line, the second switching device having a control gate coupled to the respective row line.

7. The display of claim 4, wherein the first switching device in each pixel has a first control terminal coupled to a respective row line and a second control terminal coupled to a respective column line.

8. The display of claim 7, further comprising a voltage comparator associated with each column of pixels and having a first input receiving a reference voltage corresponding to a specified luminance of a pixel in the column, and a second input connected to the optical sensor associated with each pixel in the column through a respective column line.

9. The display of claim 8, further comprising a third switching device coupled between the second control terminal of the first switching device in each pixel in the column and ground, and having a control terminal coupled to an output of the voltage comparator.

10. A method for controlling the brightness of a pixel in a display, the method comprising:
applying a line select voltage to the pixel;
generating a ramp voltage from the line select voltage in the pixel, the ramp voltage being applied to a gate of a transistor serially coupled with a light-emitting device thereby causing the transistor to turn on and current to flow through the light-emitting device, a luminance level of the light-emitting device increasing with the ramp voltage;
illuminating an optical sensor with the light from the light-emitting device thereby causing an electrical parameter associated with the optical sensor to change according to the luminance level of the light-emitting device; and
disconnecting the line select voltage from the gate of the transistor in response to the luminance level of the light-emitting device having reached a specified level for the pixel, thereby keeping the luminance level of the light-emitting device from further increasing.

11. The method of claim 10, further comprising:
charging a capacitor coupled to the transistor with the ramp voltage, the capacitor keeping the brightness of the light at the specified level after the line select voltage is disconnected from the gate of the transistor.

12. The method of claim 10, wherein generating a ramp voltage comprises:
generating the ramp voltage using an RC network formed in the pixel.

13. The method of claim 12, wherein disconnecting the line select voltage comprises:
providing a reference voltage to a first input of a voltage comparator, the reference voltage corresponding to a specified luminance for the pixel;
coupling a sensor voltage to a second input of the voltage comparator, the sensor voltage being dependent upon the electrical parameter associated with the optical sensor; and
changing an output from the voltage comparator in response to the sensor voltage being equal or greater than the reference voltage, thereby turning off a first switching device coupled between the line select voltage and the gate of the transistor.

14. The method of claim 13, wherein changing an output from the voltage comparator comprises changing the output from a logic low to a logic high corresponding to an “off” state and an “on” state, respectively, of a second switching device coupled between a control terminal of the first switching device and ground, the second switching device having a control terminal coupled to the output of the voltage comparator.

15. A pixel in a display, comprising:
a light-emitting device configured to emit light in response to a current flowing through the light-emitting device, a luminance of the light-emitting device being dependent upon the current;
a transistor configured to provide the current through the light-emitting device, the current increasing with a ramp voltage applied to a control terminal of the transistor, the ramp voltage being generated in the pixel from a line select voltage applied to the pixel; and
a first switching device configured to disconnect the line select voltage from the transistor in response to the luminance of the light-emitting device having reached a specified level.

16. The pixel of claim 15, wherein the first switching device in each pixel has a first control terminal coupled to a first conductive line, a second control terminal coupled to a second conductive line, an input coupled to the first conductive line through a resistor, and an output coupled to the control terminal of the transistor.

17. The pixel of claim 16, further comprising a capacitor or charge storage device coupled to the control terminal of the transistor, the capacitor and the resistor together forming at least part of an RC network for generating the ramp voltage in the pixel, an RC constant of the RC network being selected according to a line address time for the display.

18. The pixel of claim 16, wherein the pixel is formed on a glass substrate and the first and second conductive lines connect the pixel to off-the-glass control circuitry associated with the display.

19. The pixel of claim 16, further comprising an optical sensor associated with each pixel and coupled between the first and second conductive lines.

20. The pixel of claim 16, wherein the second control terminal of the first switching device is further coupled to the ground through a second switching device having a control gate coupled to an output of a control circuit, the output switching from a logic low for the second switching device to a logic high for the second switching device in response to the luminance of the light-emitting device in the pixel having reached the specified level.
